(19) United States
(12) Patent Application Publication
(10) Pub. No.: US 2026/0319589 A1
(43) Pub. Date: Oct. 15, 2026

(54) TOUCH GESTURES USING MULTI-MODAL SENSOR FUSION

(71) Applicant: Snap Inc., Santa Monica, CA (US)

(72) Inventors: Robert Fischer, Vienna (AT); Kai Zhou, Wiener Neudorf (AT); Connor Cabrera, Weehawken, NJ (US); Hugo De Moraes, New York City, NY (US)

(21) Appl. No.: 19/178,401

(22) Filed: Apr. 14, 2025

(51) Int. Cl. G06F 3/01

(52) U.S. Cl. CPC G06F 3/017; G06F 3/011

(57) ABSTRACT

An XR device is provided that determines a proximity of a hand of a user to the XR device using tracking data and detects a vibration indicating physical contact with the XR device using a vibration detection sensor. The XR device activates at least one audio sensor in response to the detected vibration and the proximity, analyzes audio data captured by the audio sensor to determine a touch gesture type, and performs a function based on the determined touch gesture type. The XR device uses multi-modal sensor fusion to detect touch gestures without requiring physical buttons, balancing informativeness, power efficiency, and privacy by selectively activating sensors based on their characteristics.

### TECHNICAL FIELD

The present disclosure relates generally to physical input devices and, more particularly, physical input devices used for extended reality.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term extended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user may interact with physical interface devices of a head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of an XR device in a form of a head-wearable apparatus, according to some examples.

FIG. 1B illustrates a further view of the head-wearable apparatus of FIG. 1A, according to some examples.

FIG. 2 illustrates a system in which the head-wearable apparatus is operably connected to a mobile device, according to some examples.

FIG. 3 is a diagrammatic representation of a machine in the form of a computer system, according to some examples.

FIG. 4 is a block diagram showing a software architecture, according to some examples.

FIG. 5A illustrates a collaboration diagram of components of an XR device, according to some examples.

FIG. 5B illustrates a multi-modal sensor method, according to some examples.

FIG. 6A illustrates a machine-learning pipeline, according to some examples.

FIG. 6B illustrates training and use of a machine-learning program, according to some examples.

FIG. 7A illustrates a networked environment, according to some examples.

FIG. 7B is a diagrammatic representation of a digital interaction system that has both client-side and server-side functionality, according to some examples.

### DETAILED DESCRIPTION

XR devices have relied on physical buttons for user input, which presents several challenges for device design and user experience. These physical components increase the weight of the XR device, raise manufacturing costs, and make waterproofing more difficult. Physical buttons also constrain possible form factors and design flexibility, limiting innovation in XR device design. Some user interactions with XR devices are limited to visual inputs (cameras), external hardware controllers (armbands, mobile phones), or physical on-device hardware (buttons, touchpads). While these methods provide functional input capabilities, they either require additional hardware or add complexity to the XR device design. Privacy concerns also arise with certain input methods, particularly those involving always-on sensors like audio sensors, which users may find intrusive. Additionally, powering multiple sensors continuously leads to significant power drain, which is especially problematic for wearable XR devices that need to maintain battery life throughout the day.

Previous attempts to address these issues incorporated physical touchpads and proximity sensors, which provided good user experience but at additional costs. In addition, dedicated capture buttons add to hardware complexity.

These limitations highlight the need for a more elegant solution that can provide intuitive user input without the drawbacks of physical buttons, while balancing the competing priorities of informativeness, power efficiency, and privacy.

Methodologies described herein address identified problems through a multi-modal sensor fusion approach that leverages existing hardware components in XR devices to detect touch gestures without requiring additional physical buttons. The methodologies strategically combine three existing sensors—audio sensors, pose sensors, and cameras—each contributing different information with varying levels of informativeness, power efficiency, and privacy considerations. In an example, the methodologies implement a coordinated detection process where both a “VIBRATION” state from a pose sensor and a “HAND_IMMINENT” state from a camera are determined. When both conditions are met, an XR device selectively activates audio sensors to precisely classify the gesture type (tap/swipe), location (left/right), and direction (forward/backward) through audio signal analysis.

Audio data provides a discriminative interaction signal that can distinguish between different types of touch gestures based on their unique acoustic signatures. For taps, the audio sensors detect short, loud impulses, while swipes appear as longer audio signals with changing intensity patterns. An XR device can determine swipe direction by analyzing how the audio signal amplitude changes between audio sensors during a gesture—when a swipe begins, the audio sensor closest to the starting point receives the loudest signal, and as the swipe continues, the signal strength shifts toward microphones on the opposite side.

These methodologies balance competing priorities through selective sensor activation strategies. A pose sensor provides high privacy and energy efficiency but low informativeness, while audio sensors offer high informativeness but lower privacy and energy efficiency. By activating the privacy-sensitive audio sensors only when necessary and immediately discarding audio data after processing, an XR device preserves user privacy while maintaining accurate gesture detection.

These methodologies enable the elimination of physical buttons while maintaining or enhancing user interaction capabilities, creating more lightweight, cost-effective, and waterproof XR devices with new form factor possibilities.

Other technical features can be readily apparent to one skilled in the art from the following figures, descriptions, and claims.

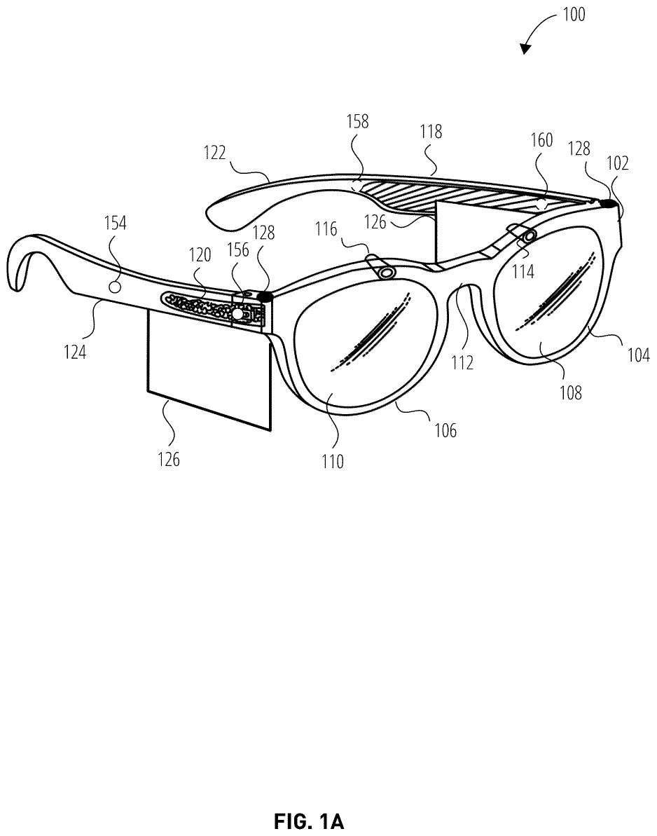

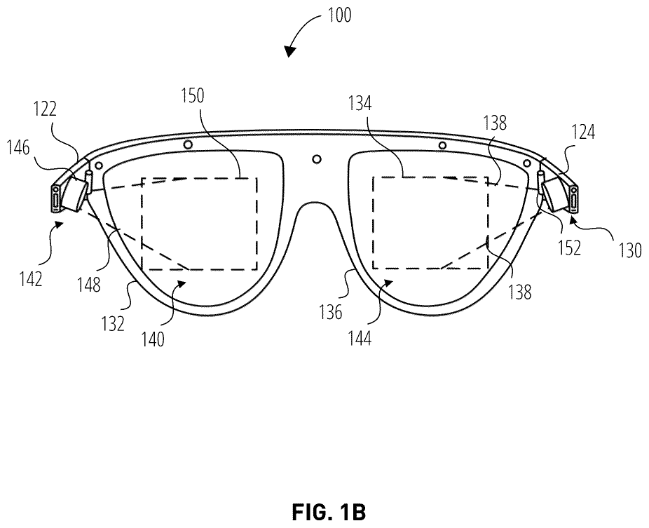

FIG. 1A is a perspective view of an XR device in a form of a head-wearable apparatus 100 according to some examples. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples, the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below, the computer 120 comprises low-power circuitry 224, high-speed circuitry 226, and a display processor. Various other examples can include these elements in different configurations or integrated together in different ways. Additional details of aspects of the computer 120 can be implemented as illustrated by the machine 300 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional cameras (e.g., two or more cameras).

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the head-wearable apparatus 100 includes a set of audio sensors 154, 156, 158, and 160 such as microphones or the like. For example, audio sensor 154 and audio sensor 156 are located on the right temple piece 124 and audio sensor 158 and audio sensor 160 are located on the left temple piece 122. The audio sensors are operable to capture audio data of acoustic signals from a real-world environment of the head-wearable apparatus 100 including ambient sounds and sounds generated by physical interaction with the head-wearable apparatus 100 itself. In some examples, these acoustic signals are processed to detect specific patterns associated with touch gestures. The audio sensors are strategically positioned around the XR device to enable accurate detection of a touch location or touch side (e.g., a touch on a left side or a right side) and gesture type (e.g., a tap or a swipe). In some examples, four audio sensors are distributed across the frame and/or temple pieces of the head-wearable apparatus 100.

In some examples, the audio data captured by the audio sensors provides a discriminative interaction signal that can be used to distinguish between different types of touch gestures based on their unique acoustic signatures. For taps, the audio sensors can detect audio signals having short, loud impulses, while swipes appear as longer audio signals with changing intensity patterns.

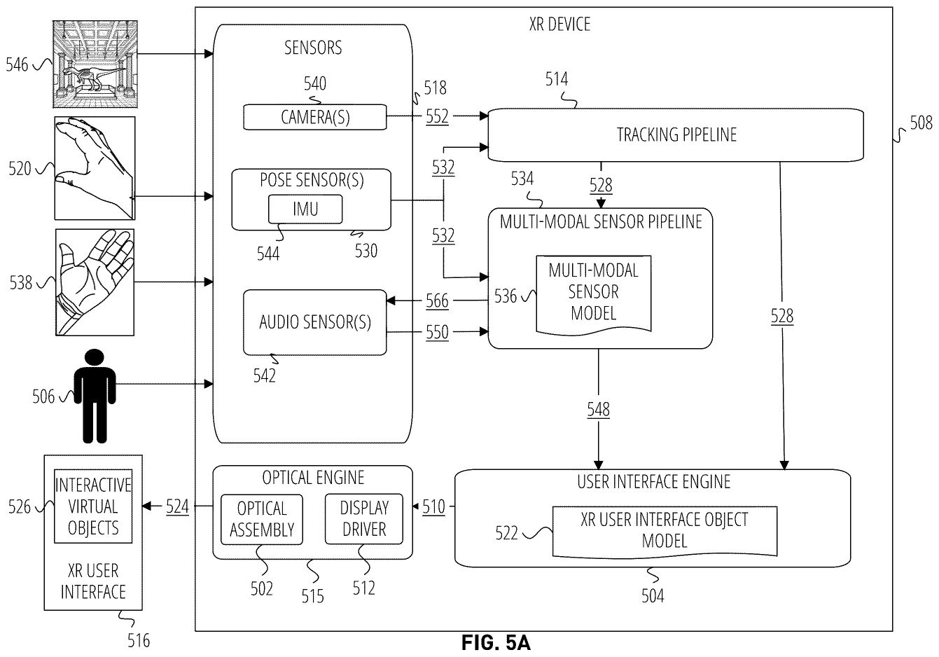

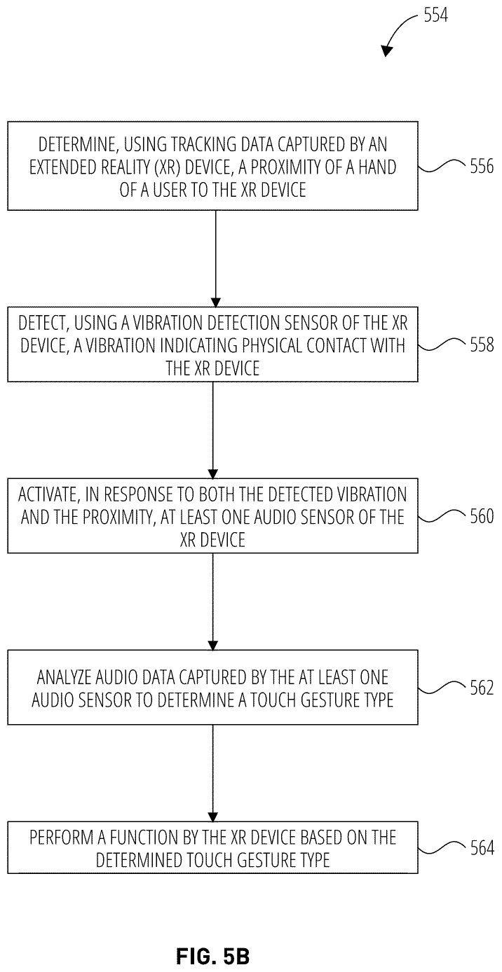

In some examples, the head-wearable apparatus 100 can determine swipe direction (forward/backward) by analyzing how the audio signal strength changes between audio sensors during a gesture as more fully described in reference to FIG. 5A and FIG. 5B.

In some examples, to address privacy concerns, the audio sensors are not continuously active and are only activated when necessary to receive audio inputs.

In some examples, the left camera 114 and the right camera 116 provide tracking image data for use by the head-wearable apparatus 100 to extract 3D information from a real-world scene.

The head-wearable apparatus 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphical Processing Unit, an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated however that other display technologies or configurations can be utilized within an optical engine to display an image to a user in the user's field of view. For example, instead of a projector and a waveguide, an LCD, LED or other display panel or surface can be provided.

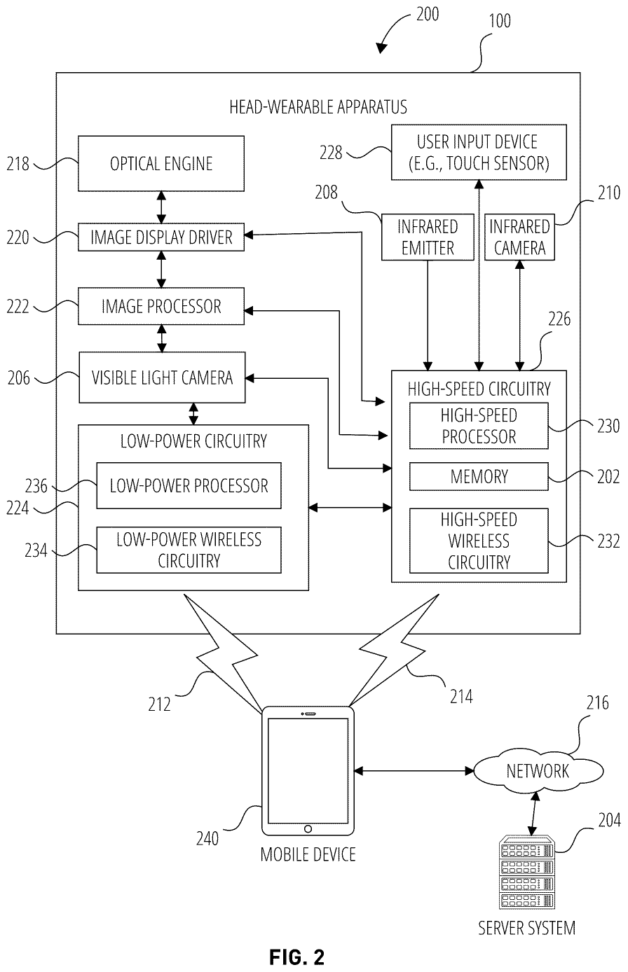

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 240 illustrated in FIG. 2), and/or hand movements, locations, and positions recognized by the head-wearable apparatus 100.

In some examples, an optical engine of an XR device is incorporated into a lens that is in contact with a user's eye, such as a contact lens or the like. The XR device generates images of an XR experience using the contact lens.

In some examples, the head-wearable apparatus 100 comprises an XR device. In some examples, the head-wearable apparatus 100 is a component of an XR device including additional computational components. In some examples, the head-wearable apparatus 100 is a component in an XR device comprising additional user input systems or devices.

FIG. 2 is a high-level functional block diagram of a system 200 including a head-wearable apparatus 100 communicatively coupled to a mobile device 240 and various server systems 204 via various communication protocols.

The head-wearable apparatus 100 includes one or more cameras, each of which can be, for example, a visible light camera 206, an infrared emitter 208, and an infrared camera 210.

The mobile device 240 connects with head-wearable apparatus 100 using both a low-power wireless connection 212 and a high-speed wireless connection 214. The mobile device 240 is also connected to the server system 204 and the networks 216.

The head-wearable apparatus 100 further includes one or more image displays of the optical engine 218. The optical engines 218 include one associated with the left lateral side and one associated with the right lateral side of the head-wearable apparatus 100. The head-wearable apparatus 100 also includes an image display driver 220, an image processor 222, low-power circuitry 224, and high-speed circuitry 226. The optical engine 218 is for presenting images and videos, including an image that can include a graphical user interface to a user of the head-wearable apparatus 100.

The image display driver 220 commands and controls the optical engine 218. The image display driver 220 can deliver image data directly to the optical engine 218 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 228 (e.g., touch sensor or push button), including an input surface on the head-wearable apparatus 100. The user input device 228 (e.g., touch sensor or push button) is to receive from the user an input selection to manipulate the graphical user interface of the presented image.

The components shown in FIG. 2 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 206 can include digital camera elements such as a complementary metal oxide-semiconductor (CMOS) image sensor, charge-coupled device, camera lenses, or any other respective visible or light-capturing elements that can be used to capture data, including images of scenes with unknown objects.

The head-wearable apparatus 100 includes a memory 202, which stores instructions to perform a subset, or all the functions described herein. The memory 202 can also include storage device.

As shown in FIG. 2, the high-speed circuitry 226 includes a high-speed processor 230, a memory 202, and high-speed wireless circuitry 232. In some examples, the image display driver 220 is coupled to the high-speed circuitry 226 and operated by the high-speed processor 230 to drive the left and right image displays of the optical engine 218. The high-speed processor 230 can be any processor capable of managing high-speed communications and operation of any general computing system needed for the head-wearable apparatus 100. The high-speed processor 230 includes processing resources needed for managing high-speed data transfers on a high-speed wireless connection 214 to a wireless local area network (WLAN) using the high-speed wireless circuitry 232. In certain examples, the high-speed processor 230 executes an operating system such as a LINUX operating system or other such operating system of the head-wearable apparatus 100, and the operating system is stored in the memory 202 for execution. In addition to any other responsibilities, the high-speed processor 230 executing a software architecture for the head-wearable apparatus 100 is used to manage data transfers with high-speed wireless circuitry 232. In certain examples, the high-speed wireless circuitry 232 is configured to implement Institute of Electrical and Electronic Engineers (IEEE) 802.11 communication standards, also referred to herein as WI-FI®. In some examples, other high-speed communications standards can be implemented by the high-speed wireless circuitry 232.

The low-power wireless circuitry 234 and the high-speed wireless circuitry 232 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 240, including the transceivers communicating via the low-power wireless connection 212 and the high-speed wireless connection 214, can be implemented using details of the architecture of the head-wearable apparatus 100, as can other elements of the network 216.

The memory 202 includes any storage device capable of storing various data and applications, including, among other things, camera data generated by the left and right visible light cameras 206, the infrared camera 210, and the image processor 222, as well as images generated for display by the image display driver 220 on the image displays of the optical engine 218. While the memory 202 is shown as integrated with high-speed circuitry 226, in some examples, the memory 202 can be an independent standalone element of the head-wearable apparatus 100. In certain such examples, electrical routing lines can provide a connection through a chip that includes the high-speed processor 230 from the image processor 222 or the low-power processor 236 to the memory 202. In some examples, the high-speed processor 230 can manage addressing of the memory 202 such that the low-power processor 236 will boot the high-speed processor 230 any time that a read or write operation involving memory 202 is needed.

As shown in FIG. 2, the low-power processor 236 or high-speed processor 230 of the head-wearable apparatus 100 can be coupled to the camera (visible light camera 206, infrared emitter 208, or infrared camera 210), the image display driver 220, the user input device 228 (e.g., touch sensor or push button), and the memory 202.

The head-wearable apparatus 100 is connected to a host computer. For example, the head-wearable apparatus 100 is paired with the mobile device 240 via the high-speed wireless connection 214 or connected to the server system 204 via the network 216. The server system 204 can be one or more computing devices as part of a service or network computing system, for example, that includes a processor, a memory, and network communication interface to communicate over the network 216 with the mobile device 240 and the head-wearable apparatus 100.

The mobile device 240 includes a processor and a Network communication interface coupled to the processor. The Network communication interface allows for communication over the network 216, low-power wireless connection 212, or high-speed wireless connection 214. The mobile device 240 can further store at least portions of the instructions in the memory of the mobile device 240 memory to implement the functionality described herein.

Output components of the mobile device 240 include visual components, such as a display such as a liquid crystal display (LCD), a plasma display panel (PDP), a light-emitting diode (LED) display, a projector, or a waveguide. The image displays of the optical assembly are driven by the image display driver 220. The output components of the mobile device 240 further include acoustic components (e.g., speakers), haptic components (e.g., a vibratory motor), other signal generators, and so forth. The input components of the mobile device 240, the mobile device 240, and server system 204, such as the user input device 228, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., an audio sensor), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such elements described herein.

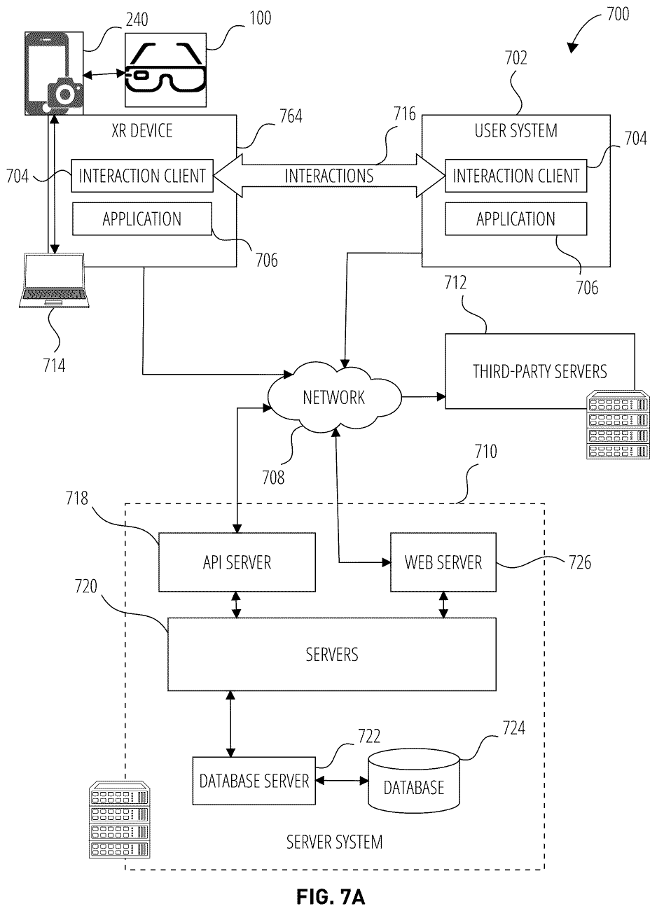

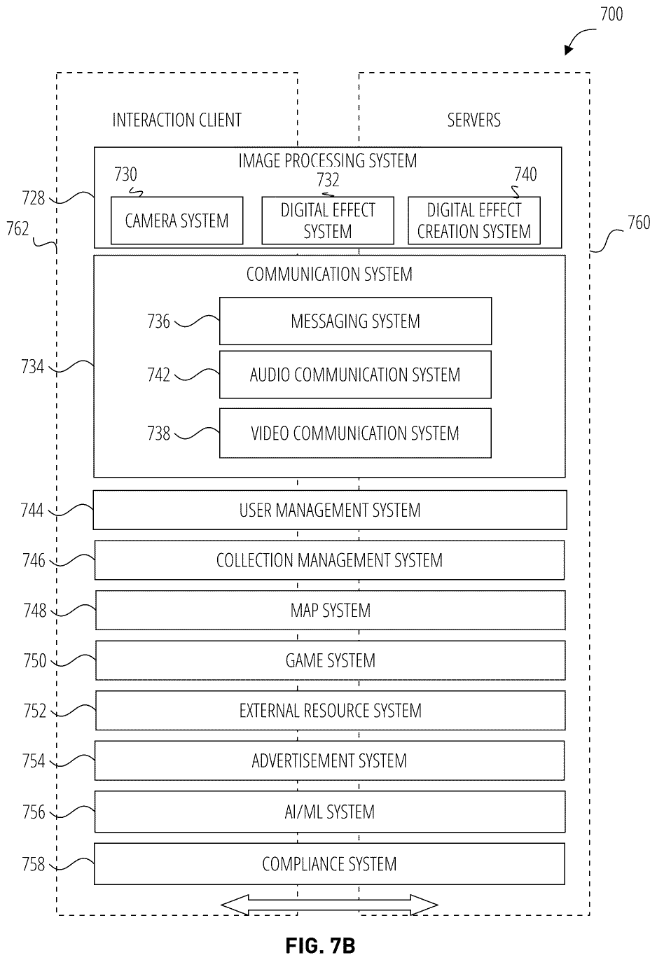

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, electroencephalogram-based identification, hand-based identification), and the like. Any biometric data collected by the biometric components or sensors is captured and stored with only user approval and deleted on user request, and in accordance with applicable laws. Further, such biometric data is used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the biometric data is not shared or sold to any third party without the explicit consent of the user. All biometric data is permanently destroyed when the initial purpose for collecting or obtaining such data has been satisfied. In addition, appropriate technical and organizational measures are implemented to ensure the security and confidentiality of this sensitive information as more fully described in reference to FIG. 7B

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 212 and high-speed wireless connection 214 from the mobile device 240 via the low-power wireless circuitry 234 or high-speed wireless circuitry 232.

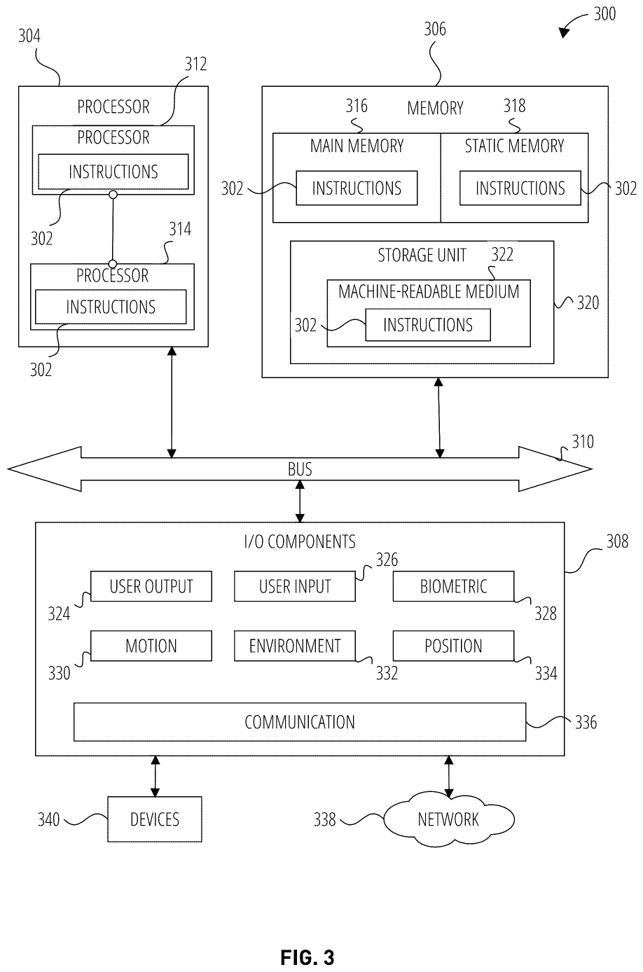

FIG. 3 is a diagrammatic representation of the machine 300 within which instructions 302 (e.g., software, a program, an application, an applet, an app, or other executable code) for causing the machine 300 to perform any one or more of the methodologies discussed herein can be executed. For example, the instructions 302 can cause the machine 300 to execute any one or more of the methods described herein. The instructions 302 transform the general, non-programmed machine 300 into a particular machine 300 programmed to carry out the described and illustrated functions in the manner described. The machine 300 can operate as a standalone device or can be coupled (e.g., networked) to other machines. In a networked deployment, the machine 300 can operate in the capacity of a server machine or a client machine in a server-client network environment, or as a peer machine in a peer-to-peer (or distributed) network environment. The machine 300 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 302, sequentially or otherwise, that specify actions to be taken by the machine 300. Further, while a single machine 300 is illustrated, the term “machine” shall also be taken to include a collection of machines that individually or jointly execute the instructions 302 to perform any one or more of the methodologies discussed herein. The machine 300, for example, can comprise the user system 702 or any one of multiple server devices forming part of the server system 710. In some examples, the machine 300 can also comprise both client and server systems, with certain operations of a particular method or algorithm being performed on the server-side and with certain operations of the method or algorithm being performed on the client-side.

The machine 300 can include one or more hardware processors 304, memory 306, and input/output I/O components 308, which can be configured to communicate with each other via a bus 310.

The processor 304 can comprise one or more processors such as, but not limited to, processor 312 and processor 314. The one or more processors can comprise one or more types of processing systems such as, but not limited to, Central Processing Units (CPUs), Graphics Processing Units (GPUs), Digital Signal Processors (DSPs), Neural Processing Units (NPUs) or AI Accelerators, Physics Processing Units (PPUs), Field-Programmable Gate Arrays (FPGAs), Multi-core Processors, Symmetric Multiprocessing (SMP) Systems, and the like.

The memory 306 includes a main memory 316, a static memory 318, and a storage unit 320, both accessible to the processor 304 via the bus 310. The main memory 306, the static memory 318, and storage unit 320 store the instructions 302 embodying any one or more of the methodologies or functions described herein. The instructions 302 can also reside, completely or partially, within the main memory 316, within the static memory 318, within machine-readable medium 322 within the storage unit 320, within at least one of the processor 304 (e.g., within the processor's cache memory), or any suitable combination thereof, during execution thereof by the machine 300.

The I/O components 308 can include a wide variety of components to receive input, provide output, produce output, transmit information, exchange information, capture measurements, and so on. The specific I/O components 308 that are included in a particular machine will depend on the type of machine. For example, portable machines such as mobile phones can include a touch input device or other such input mechanisms, while a headless server machine will likely not include such a touch input device. It will be appreciated that the I/O components 308 can include many other components that are not shown in FIG. 3. In various examples, the I/O components 308 can include user output components 324 and user input components 326. The user output components 324 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 326 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., an audio sensor), and the like.

In further examples, the I/O components 308 can include biometric components 328, motion components 330, environmental components 332, or position components 334, among a wide array of other components. For example, the biometric components 328 can include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification, hand-based identification), and the like. Any biometric data collected by the biometric components or sensors is captured and stored with only user approval and deleted on user request, and in accordance with applicable laws. Further, such biometric data is used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information. All biometric data is permanently destroyed when the initial purpose for collecting or obtaining such data has been satisfied.

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. In addition, appropriate technical and organizational measures are implemented to ensure the security and confidentiality of this sensitive information.

The motion components 330 include acceleration sensor components (e.g., accelerometer), gravitation sensor components, rotation sensor components (e.g., gyroscope).

The environmental components 332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more audio sensors that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

With respect to cameras, the user system 702 can have a camera system comprising, for example, front cameras on a front surface of the user system 702 and rear cameras on a rear surface of the user system 702. The front cameras can, for example, be used to capture still images and video of a user of the user system 702 (e.g., “selfies”), which can then be modified with digital effect data (e.g., filters) described above. The rear cameras can, for example, be used to capture still images and videos in a more traditional camera mode, with these images similarly being modified with digital effect data. In addition to front and rear cameras, the user system 702 can also include a 360° camera for capturing 360° photographs and videos.

Moreover, the camera system of the user system 702 can be equipped with advanced multi-camera configurations. This can include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 702 can also feature triple, quad, or even penta camera configurations on both the front and rear sides of the user system 702. These multiple cameras systems can include a wide camera, an ultra-wide camera, a telephoto camera, a macro camera, and a depth sensor, for example.

Communication can be implemented using a wide variety of technologies. The I/O components 308 further include communication components 336 operable to couple the machine 300 to a Network 338 or devices 340 via respective coupling or connections. For example, the communication components 336 can include a network interface component or another suitable device to interface with the Network 338. In further examples, the communication components 336 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 340 can be another machine or any of a wide variety of peripheral devices (e.g., a peripheral device coupled via a USB).

Moreover, the communication components 336 can detect identifiers or include components operable to detect identifiers. For example, the communication components 336 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., audio sensors to identify tagged audio signals). In addition, a variety of information can be derived via the communication components 336, such as location via Internet Protocol (IP) geolocation, location via Wi-Fi® signal triangulation, location via detecting an NFC beacon signal that can indicate a particular location, and so forth.

The various memories (e.g., main memory 316, static memory 318, and memory of the processor 304) and storage unit 320 can store one or more sets of instructions and data structures (e.g., software) embodying or used by any one or more of the methodologies or functions described herein. These instructions (e.g., the instructions 302), when executed by processor 304, cause various operations to implement the disclosed examples.

The instructions 302 can be transmitted or received over the Network 338, using a transmission medium, via a network interface device (e.g., a network interface component included in the communication components 336) and using any one of several well-known transfer protocols (e.g., hypertext transfer protocol (HTTP)). Similarly, the instructions 302 can be transmitted or received using a transmission medium via a coupling (e.g., a peer-to-peer coupling) to the devices 340.

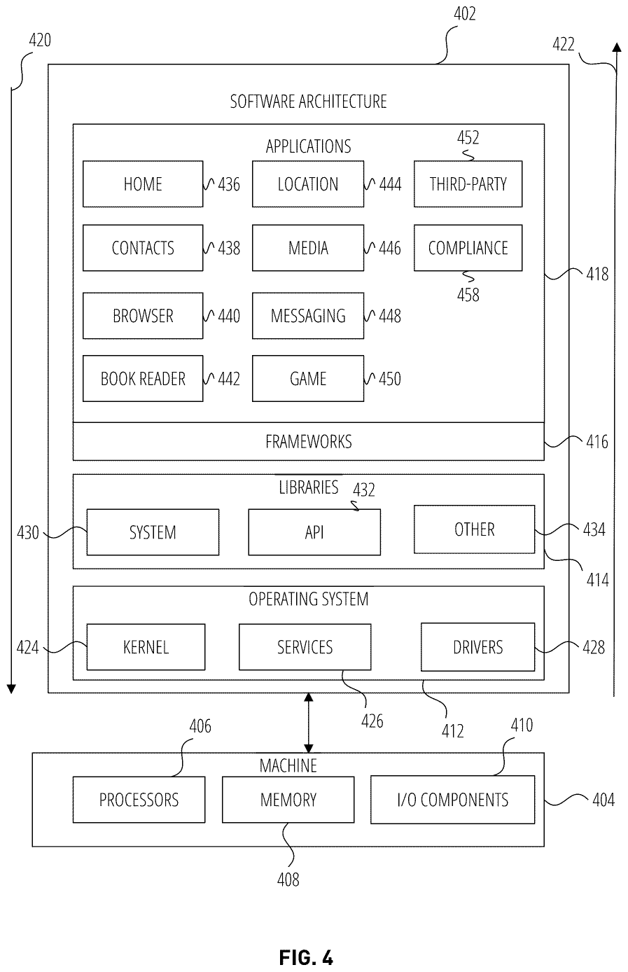

FIG. 4 is a software architecture diagram illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematical functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which can be specific to a particular operating system or platform.

In an example, the applications 418 can include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs.

In some examples, the applications 418 can include a compliance application 458 that facilitates compliance by a device or system with data privacy and other regulations, including for example the California Consumer Privacy Act (CCPA), General Data Protection Regulation (GDPR), and Digital Services Act (DSA). The compliance application 458 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance application 458 also incorporates opt-in/opt-out management and privacy controls across a digital interaction system, empowering users to manage their data preferences. The compliance application 458 is designed to handle sensitive data by obtaining explicit consent, implementing strict access controls and in accordance with applicable laws.

Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

FIG. 5A illustrates a collaboration diagram of components of an XR device 508, such as head-wearable apparatus 100 of FIG. 1A, using hand-tracking for user input, according to some examples. The XR device 508 uses tracking data 528 to provide a continuous real-time input modalities to a user 506 of the XR device 508 where the user 506 interacts with one or more XR user interfaces 516 using hand-tracking and hand touch input modalities.

While in use, the XR device 508 uses a set of sensors 518 to detect and record a position, orientation, and gestures of the hands 520 and 538 of the user 506. This can involve capturing the speed and trajectory of hand movements, recognizing specific hand poses, and determining the relative positioning of the hands in a 3D space of an XR environment.

In some examples, the sensors 518 comprise an array of optical sensors capable of capturing a wide range of hand movements and gestures in real-time as images. These sensors can include a set of cameras 540. A subset of the cameras can be Red Green and Blue (RGB) cameras that capture images of the hands of the user 506 using light having a broad wavelength spectrum, such as natural light provided by the real-world environment or artificial illumination created by one or more incandescent lamps, LED lamps, or the like provided by the XR device 508. In some examples, a subset of the cameras 540 can include infrared cameras that capture images of the hands 520 of the user 506 using energy in the infrared radiation (IR) spectrum. The IR energy can be supplied by one or more IR emitters of the XR device 508.

In some examples, the sensors 518 include a set of depth-sensing sensors that utilize structured light or time-of-flight technology to create a 3D model of the hands 520 of the user 506. This allows the XR device 508 to detect intricate gestures and finger movements with high accuracy.

In some examples, the sensors 518 comprise ultrasonic sensors that emit sound waves and measure the reflection off the hands of the user 506 to determine their location and movement in space.

In some examples, the sensors 518 include a set of electromagnetic field sensors that track the movement of the hands 520 of the user 506 by detecting changes in an electromagnetic field generated around the user 506.

In some examples, the sensors 518 include capacitive sensors embedded in gloves worn by the user 506. These sensors detect hand movements and gestures based on changes in capacitance caused by finger positioning and orientation.

In some examples, the XR device 508 includes a set of pose sensors 530 such as an Inertial Measurement Unit (IMU) 544 and the like, that track the orientation and movements of the XR device of the user 506. The pose sensors 530 are used to determine Six Degrees of Freedom (6DoF) data of movement of the XR device 508 in three-dimensional space. Specifically, the 6DoF data encompasses three translational movements along the x, y, and z axes (forward/back, up/down, left/right) and three rotational movements (pitch, yaw, roll) included in pose data 532. In the context of XR, 6DoF data is allows for the tracking of both position and orientation of an object or user in 3D space. In some examples, the XR device 508 is a head-wearable apparatus worn by the user 506 in which case the location, gaze direction, and orientation of the user can be inferred from the 6DoF data of the XR device.

In some examples, the pose sensors 530 include one or more cameras that capture images of the real-world environment. The images are included in the pose data 532. A tracking pipeline 514 XR device 508 uses the images and photogrammetric methodologies to determine the 6DoF data of the XR device 508.

In some examples, the XR device 508 uses a combination of an IMU and a set of cameras to determine 6DoF for the XR device 508.

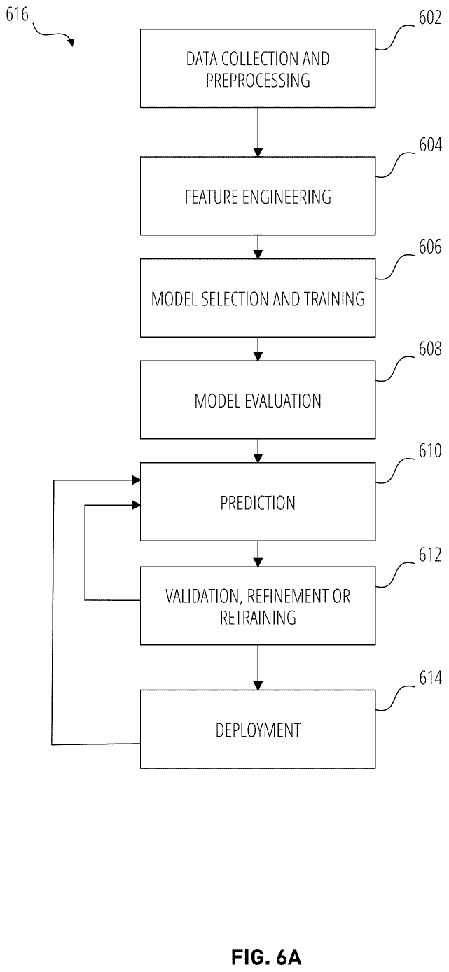

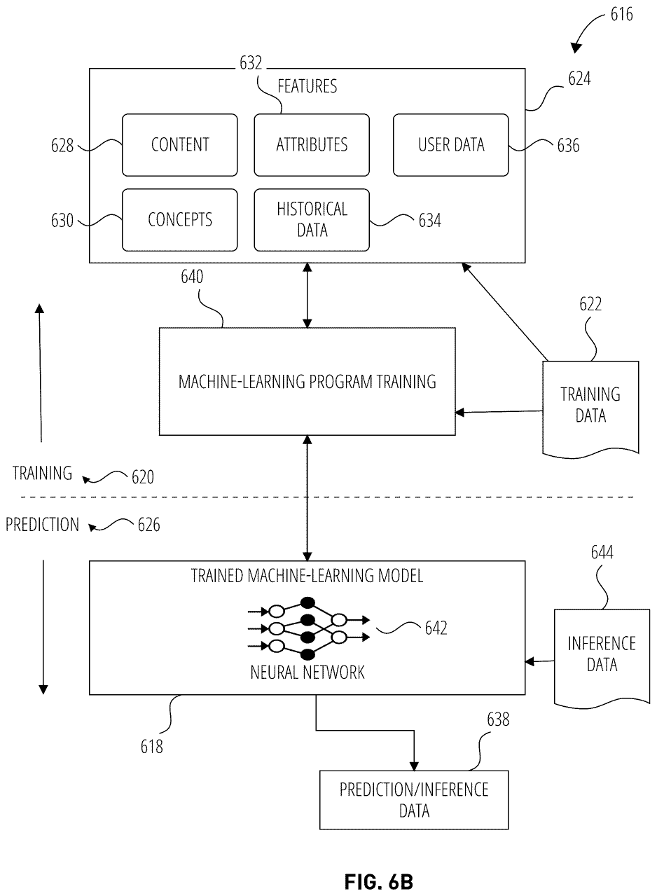

The XR device 508 uses the tracking pipeline 514 to determine tracking data 528 based on the image data 552 generated by the set of cameras 540 and pose data 532 generated by the set of pose sensors 530. For example, the tracking pipeline 514 includes a Region Of Interest (ROI) detector, a tracker, and a 3D model generator used to generate the tracking data 528 using the image data 552 and the pose data 532. The ROI detector uses a ROI detector model to detect a region in the real world environment that includes the hands 520 and 538 of the user 506. The ROI detector model is trained to recognize those portions of the real-world environment that include a user's hands as more fully described in reference to FIG. 6A and FIG. 6B. The ROI detector generates ROI data indicating which portions of the image data 552 include the one or more hands of the user 506 and communicates the ROI data to the tracker.

The tracker uses the 2D image data and a tracking model to generate 2D tracking data. The tracker uses the tracking model to recognize landmark features on portions of the hands 520 and 538 of the user 506 captured in the image data 552 and within the ROI identified by the ROI detector. The tracker extracts landmarks of the hands 520 and 538 of the user 506 from the image data 552 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The tracking model operates on the landmarks to generate the 2D tracking data that includes a sequence of skeletal models of one or more hands of the user 506. The tracking model is trained to generate the 2D tracking data as more fully described in reference to FIG. 6A and FIG. 6B. The tracker communicates the 2D tracking data to the 3D model generator.

The 3D model generator receives the 2D tracking data and generates 3D tracking data using the 2D tracking data, the pose data 532, and a 3D coordinate generator model. For example, the 3D model generator determines a reference position in the real-world environment 546 for the XR device 508. The 3D model generator uses a 3D coordinate generator model that operates on the 2D tracking data to generate the tracking data 528. The 3D coordinate generator model is trained to generate the tracking data 528 as more fully described in reference to FIG. 6A and FIG. 6B.

In some examples, the tracker generates the tracking data 528 using photogrammetry methodologies to create 3D models of the hands of the user 506 from the 2D tracking data by capturing overlapping pictures of the hands of the user 506 from different angles. In some examples, the 2D tracking data includes multiple images taken from different angles, which are then processed to generate the 3D models that are included in the tracking data 528. In some examples, the XR device 508 uses the pose data 532 captured by pose sensor 530 to determine an angle or position of the XR device 508 as an image is captured of the hands of the user 506.

In some examples, the XR device includes a multi-modal sensor pipeline 534 that uses a multi-modal sensor model 536 to generate multi-modal sensor data 548 using the pose data 532 and audio data 550 generated by a set of audio sensors 542 as more fully described in reference to FIG. 5B. The user interface engine 504 uses the multi-modal sensor data 548 along with the tracking data 528 as user input data as the user interacts with an XR user interface 516.

The XR device 508 generates the XR user interface 516 provided to the user 506 within an XR environment. The XR user interface 516 include interactive virtual objects 526 that the user 506 can interact with. For example, a user interface engine 504 of FIG. 5A includes an XR user interface controller comprising a dialog script or the like that specifies a user interface dialog implemented by the XR user interface 516. The XR user interface controller also comprises functionality to implement one or more actions that are to be taken by the XR device 508 based on detecting various dialog events such as user inputs input by the user 506 using the XR user interface 516.

The user interface engine 504 further includes an XR user interface object model 522. The XR user interface object model 522 includes 3D coordinate data of the interactive virtual objects 526 of the XR user interface 516. The XR user interface object model 522 also includes 3D graphics data of the interactive virtual objects 526. The 3D graphics data is used by an optical engine 515 to generate the XR user interface 516 for display to the user 506.

The user interface engine 504 generates XR user interface data 510 using the XR user interface object model 522. The XR user interface data 510 includes image data of the interactive virtual objects 526 of the XR user interface 516. The user interface engine 504 communicates the XR user interface data 510 to a display driver 512 of an optical engine 515 of the XR device 508. The display driver 512 receives the XR user interface data 510 and generates display control signals using the XR user interface data 510. The display driver 512 uses the display control signals to control the operations of one or more optical assemblies 502 of the optical engine 515. In response to the display control signals, the one or more optical assemblies 502 generate an XR user interface graphics display 524 of the XR user interface 516 that is provided to the user 506.

In some examples, the XR device 508 is operably connected to a mobile device (not shown). The user 506 can use the mobile device to configure the XR device 508. In some examples, the mobile device functions as a user input modality.

In some examples, an XR device performs the functions of the tracking pipeline 514, the multi-modal sensor pipeline 534, the user interface engine 504, and the optical engine 515 utilizing various APIs and system libraries.

FIG. 5B illustrates an example multi-modal sensor method 554, according to some examples. An XR device 508 uses the multi-modal sensor method 554 to provide a multi-modal sensor input modality that integrates signals from a set of different types of sensors. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of XR device or system that implement the method may perform functions at substantially the same time or in a specific sequence.

In operation 556, the XR device 508, determines, using tracking data 528 captured by the XR device 508, a proximity of a hand of a user to the XR device 508. For example, a multi-modal sensor pipeline 534 receives the tracking data 528 from the tracking pipeline 514 and determines a proximity of a hand of a user to the XR device using the tracking data 528. The multi-modal sensor pipeline 534 of the XR device 508 uses the tracking data 528 generated by the tracking pipeline 514 to detect if a hand of the user 506 is moving closer to the XR device 508, which serves as a prior indication of a potential interaction by the user 506 with the XR device 508. In some examples, the tracking pipeline 514 uses the image data 552 to determine a 3D position of a hand of the user 506 relative to the XR device 508. The 3D position of the hand of the user 506 relative to the XR device 508 is included in the tracking data 528 and used by the multi-modal sensor pipeline 534 to determine the proximity of the hand of the user to the XR device 508.

In some examples, a proximity detection helps filter out false positives. For example, if both hands 520 and 538 of the user are visible in front of the XR device 508, touch gestures on a frame or temple piece of the XR device are disabled since the user 506 cannot be touching the XR device 508 at that moment.

In some examples, when the multi-modal sensor pipeline 534 detects that a hand of the user 506 is moving towards the XR device 508, the multi-modal sensor pipeline 534 sets a “HAND_IMMINENT” state indicating that a touch gesture on the XR device 508 made by the user 506 might be imminent.

In some examples, the tracking data 528 includes information about a trajectory of a hand of the user 506, allowing the multi-modal sensor pipeline 534 to determine if a movement pattern of the trajectory indicates an approaching hand of the user 506 that is likely to make contact with the XR device 508.

In operation 558, the XR device 508 detects, using a vibration detection sensor of the XR device, a vibration indicating physical contact with the XR device. For example, the vibration detection sensor comprises the IMU 544 of the XR device 508, which can detect significant spikes in acceleration data when the XR device 508 is physically touched. the multi-modal sensor pipeline 534 receives pose data 532 from the IMU 544 and detects a vibration indicating physical contact with the XR device using a vibration detection sensor.

In some examples, the IMU 544 provides very high frequency signals that can capture these vibrations with high temporal resolution while consuming relatively low power compared to other sensors in the XR device 508. Physical touches of the XR device 508 create distinctive vibration patterns that are not observed during normal usage of the XR device.

When a user taps or swipes on the temple of the XR device 508, the contact creates vibrations that propagate through the frame of the XR device 508 and are detected by an accelerometer component of the IMU 544. Data of the captured vibrations a communicated by the IMU 544 to a multi-modal sensor pipeline 534 as part of pose data 532. In some examples, the multi-modal sensor pipeline 534 analyzes the data of the vibrations over time to determine if they match patterns consistent with intentional touch gestures.

In some examples, upon detecting such a vibration pattern, the multi-modal sensor pipeline 534 sets a “VIBRATION” state which serves as a condition, along with the “HAND_IMMINENT” state determined using the tracking data 528, for activating a set of audio sensors 542 of the XR device 508 to perform more detailed gesture classification.

In operation 560, XR device 508 activates, in response to both the detected vibration and the proximity, at least one audio sensor of the XR device 508. For example, the multi-modal sensor method 554 activates at least one audio sensor of the audio sensors 542 of the XR device 508 in response to both the detected vibration and the proximity. In some examples, this activation occurs when two conditions are met-the “VIBRATION” state is set based on the vibration data in the pose data 532 from the IMU 544 and the “HAND_IMMINENT” state is set based on the generation of the tracking data 528 generated by the tracking pipeline 514 using image data 552.

In some examples, the multi-modal sensor pipeline 534 follows a decision tree approach where the audio sensors 542, which are associated with elevated privacy concerns and consume more power than the other sensors 518 of the XR device 508, are only turned on using a control signal 566 when there is strong evidence that a genuine touch gesture is occurring. This selective activation strategy enhances the preservation of privacy (since the audio sensors 542 are very privacy-sensitive) and optimizing power consumption (since the audio sensors 542 draw significant power).

Once activated, the audio sensors 542 capture the acoustic signals generated by the physical interaction with the XR device 508 by the user 506 touching the XR device 508 with a hand of the user 506. The audio data 550 of the acoustic signals can be analyzed to determine the specific touch gesture type, location, and direction. The multi-modal sensor pipeline 534 immediately begins processing the audio data to classify the gesture, and after the classification is complete, the audio sensors 154 are deactivated using the control signal 566 and all audio data 550 is discarded to maintain privacy. This conditional activation approach represents a balance between informativeness, power efficiency, and privacy considerations.

In operation 562, the XR device 508 analyzes audio data 550 captured by at least one audio sensor to determine a touch gesture type. For example, the multi-modal sensor pipeline 534 analyzes the audio data 550 captured by at least one audio sensor to determine a touch gesture type. Once the at least on audio sensor is activated (after detecting both vibration and hand proximity), the multi-modal sensor pipeline 534 processes the captured audio data 550 to classify the specific gesture.

In some examples, to determine a touch location or a touch side (e.g., a location on a left side or a right side of the XR device 508), the multi-modal sensor pipeline 534 compares the amplitudes of audio signals between two or more audio sensors as the audio sensor closest to a location of a touch gesture receives an audio signal having an amplitude higher than audio sensors on an opposite side of the XR device 508. In some examples, a left temple piece and a right temple piece of the XR device 508 include respective left side and right side audio sensors. The multi-modal sensor pipeline 534 can use audio signals captured from the left side and right side audio sensors to determine which temple piece is being touched by the user 506. For example, when an audio signal having a high amplitude is being received from a right side audio sensor and an audio signal having a low amplitude is received from a left side audio sensor, the multi-modal sensor pipeline 534 determines that the user is touching or otherwise interacting with the right temple piece. In a similar manner, when an audio signal having a high amplitude is being received from a left side audio sensor and an audio signal having a low amplitude is received from a right side audio sensor, the multi-modal sensor pipeline 534 determines that the user is touching or otherwise interacting with the left temple piece.

In some examples, the multi-modal sensor pipeline 534 can determine a swipe direction (e.g., forward from the back of a temple piece to a front of the temple piece or backward from the front of the temple piece to a back of the temple piece), by analyzing how an amplitude of an audio signal changes over time between different audio sensors during the gesture.

In some examples, the XR device 508 can use two or more audio sensors to increase an accuracy of a gesture detection by analyzing the change in an amplitude of an audio signal over time across different audio sensors positioned around the temple pieces and/or frame of the XR device 508.

In some examples, a swipe direction, such as backward from a back of a temple piece of the XR device 508 to a front of the temple piece, forward from a front of the temple piece to a back of the temple piece, from left to right or right to left along a frame of the XR device 508, and the like, can be determined using the audio data 550. For example, when a temple piece has one audio sensor, the direction of the swipe can be determined from how the amplitude of the audio signal from the audio sensor changes with time.

In an example, when the audio sensor is mounted in a front portion of the temple piece, detecting that an amplitude of the audio signal starts out high and diminishes with time indicates that a swipe gesture is backward from front to back on the temple piece.

Conversely, detecting that an amplitude of the audio signal starts out low and increases with time indicates that a swipe gesture is forward from back to front on the temple piece.

In another example, if the audio sensor is mounted in a back portion of a temple piece, detecting an amplitude of an audio signal that starts out high and diminishes with time indicates that a swipe gesture is forward from back to front on the temple piece. Conversely, detecting an amplitude of an audio signal that starts out low and increases with time indicates that a swipe gesture is backward from front to back on the temple piece

In some examples, when two audio sensors are mounted on a temple piece with a first audio sensor mounted in a front portion of the temple piece and a second audio sensor mounted on a back portion of the temple piece, the direction of a swipe gesture can be determined by comparing the amplitudes of the audio signals of the two audio sensors. For example, when the amplitude of a first audio signal from the first or front audio sensor starts out high and diminishes with time while an amplitude of a second audio signal from the second or back audio sensor captured during the same time period as the first audio signal starts out low and then becomes high indicates a back to front swipe gesture. In a similar manner, when the amplitude of a first audio signal from the first or front audio sensor starts out low and increases with time while an amplitude of a second audio signal from the second or back audio sensor captured during the same time period as the first audio signal starts out high and then diminishes in time indicates a front to back swipe gesture.

In some examples, a left portion of a frame of the XR device 508 and a right portion of the frame include respective left and right audio sensors. The multi-modal sensor pipeline 534 can use audio signals captured from the left and right audio sensors to determine a direction of a swipe across the frame of the XR device 508.

In some examples, the multi-modal sensor pipeline 534 analyzes audio patterns in the audio signals received from the audio sensors to distinguish between different types of touch gestures based on their unique acoustic signatures. For example, for taps, the multi-modal sensor pipeline 534 detects short, loud impulses in the audio data 550, while swipes appear as longer audio signals with changing intensity patterns.

In some examples, the XR device 508 implements a filtering mechanism to reduce false detections by comparing multiple sensor inputs against each other. For example, when a touch gesture is detected through audio analysis of the audio sensors, the multi-modal sensor pipeline 534 validates this detection by checking for consistency with both the detected vibration from the IMU and the determined hand proximity from the hand tracking system.

In an example, the multi-modal sensor pipeline 534 uses the hand tracking data 528 to verify that a detected touch location or touch side is consistent with which hand is approaching the XR device 508. For instance, if the left hand is the hand that triggered entering a “HAND_IMMINENT” state, then a touch on the left side of the XR device 508 is expected (and vice versa for the right hand). If the audio analysis indicates a touch on the right side of the XR device 508 but the hand tracking data 528 shows the left hand approaching, this inconsistency would flag a potential false detection.

In additional examples, as the IMU provides signals with very high frequency, the vibration patterns detected should be consistent with the audio signals captured by the audio sensors. The multi-modal sensor pipeline 534 compares the timing and intensity of the vibration with the audio pattern to ensure they represent the same physical interaction event.

This multi-modal validation approach significantly reduces false positives by requiring agreement between three independent sensing modalities (vibration detection, hand proximity, and audio analysis), making the XR device 508 more robust against environmental noise or accidental activations.

In some examples, the analysis of the audio data 550 includes transforming the audio data 550 into a frequency domain representation, such as a Mel spectrogram or the like, where an x-axis represents time and the an-axis represents frequency strength. In these spectrograms, different gesture types create separable patterns that can be identified either through a lightweight machine learning multi-modal sensor model 536 or other similar methods.

In operation 564, XR device 508 performs a function by the XR device based on the determined touch gesture type. For example, the multi-modal sensor pipeline 534 communicates a determined touch gesture type as part of multi-modal sensor data 548 to the user interface engine 504. The user interface engine 504 receives the multi-modal sensor data 548 as a user input and performs a function of the XR device 508 based on the determined touch gesture type.

The functions performed can include various operations such as capturing media, navigating content, controlling playback, scrolling through lists, and the like. For example, tap gestures might trigger actions like starting/stopping a recording, while swipe gestures can enable navigation actions such as going back/forward in a browser or skipping to previous/next songs during music playback.

This user input modality effectively replaces or enhances physical buttons on the AR XR device 508, allowing for a more lightweight, cost-effective, and waterproof design. The multi-modal sensor pipeline 534 can also support additional gesture types beyond what physical buttons could provide, such as directional swipes that enable more intuitive navigation in situations where hand tracking might be inconvenient, such as when in a train or car.

The implementation finds the optimal balance between accuracy, power efficiency, and privacy concerns, ensuring that the performed functions respond reliably to the user's intentions while maintaining battery life and respecting user privacy by discarding any captured audio data after processing.

### Machine-Learning Pipeline

FIG. 6B is a flowchart depicting a machine-learning pipeline 616, according to some examples. The machine-learning pipeline 616 can be used to generate a trained machine-learning model 618 such as, but not limited to a multi-modal sensor model 536 of FIG. 5A, and the like, to perform operations associated with determining user inputs into an XR device, such as XR device 508 of FIG. 5A.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 618 can include multiple phases that form part of the machine-learning pipeline 616, including for example the following phases illustrated in FIG. 6A:
Data collection and preprocessing 602: This phase can include acquiring and cleaning data to ensure that it is suitable for use in the machine learning model. This phase can also include removing duplicates, handling missing values, and converting data into a suitable format.
Feature engineering 604: This phase can include selecting and transforming the training data 622 to create features that are useful for predicting the target variable. Feature engineering can include (1) receiving features 624 (e.g., as structured or labeled data in supervised learning) and/or (2) identifying features 624 (e.g., unstructured or unlabeled data for unsupervised learning) in training data 622.
Model selection and training 606: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 608: This phase can include evaluating the performance of a trained model (e.g., the trained machine-learning model 618) on a separate testing dataset. This phase can help determine if the model is overfitting or underfitting and determine whether the model is suitable for deployment.
Prediction 610: This phase involves using a trained model (e.g., trained machine-learning model 618) to generate predictions on new, unseen data.
Validation, refinement or retraining 612: This phase can include updating a model based on feedback generated from the prediction phase, such as new data or user feedback.
Deployment 614: This phase can include integrating the trained model (e.g., the trained machine-learning model 618) into a more extensive system or application, such as a web service, mobile app, or IoT device. This phase can involve setting up APIs, building a user interface, and ensuring that the model is scalable and can handle large volumes of data.

FIG. 6B illustrates further details of two example phases, namely a training phase 620 (e.g., part of the model selection and trainings 606) and a prediction phase 626 (part of prediction 610). Prior to the training phase 620, feature engineering 604 is used to identify features 624. This can include identifying informative, discriminating, and independent features for effectively operating the trained machine-learning model 618 in pattern recognition, classification, and regression. In some examples, the training data 622 includes labeled data, known for pre-identified features 624 and one or more outcomes. Each of the features 624 can be a variable or attribute, such as an individual measurable property of a process, article, system, or phenomenon represented by a data set (e.g., the training data 622). Features 624 can also be of different types, such as numeric features, strings, and graphs, and can include one or more of content 628, concepts 630, attributes 632, historical data 634, and/or user data 636, merely for example.

In some examples, the training data 622 includes pose data captured using a pose sensor such as an IMU or the like. The pose data includes vibrations captured as a user touches an XR device. The training data 622 further includes audio data captured using audio sensors as a user interacts with an XR device using touch gestures such as, but not limited to, swipe gestures and tapping gestures. The pose data and the audio data are annotated to indicate specific touch gesture types of gestures that were performed by a user of an XR device as the pose data and audio data were captured. In some examples, the pose data and the audio data are simulated data generated by computer simulations of pose sensor data and audio sensor data as they would be generated from the perspective of a head-wearable apparatus being worn by a user as they interacted with an XR device in a real-world environment.

In training phase 620, the machine-learning pipeline 616 uses the training data 622 to find correlations among the features 624 that affect a predicted outcome or prediction/inference data 638.

With the training data 622 and the identified features 624, the trained machine-learning model 618 is trained during the training phase 620 during machine-learning program training 640. The machine-learning program training 640 appraises values of the features 624 as they correlate to the training data 622. The result of the training is the trained machine-learning model 618 (e.g., a trained or learned model).

Further, the training phase 620 can involve machine learning, in which the training data 622 is structured (e.g., labeled during preprocessing operations). The trained machine-learning model 618 implements a neural network 642 capable of performing, for example, classification and clustering operations. In other examples, the training phase 620 can involve deep learning, in which the training data 622 is unstructured, and the trained machine-learning model 618 implements a deep neural network 642 that can perform both feature extraction and classification/clustering operations.

In some examples, a neural network 642 can be generated during the training phase 620, and implemented within the trained machine-learning model 618. The neural network 642 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 642 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 642 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 620, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 626, the trained machine-learning model 618 uses the features 624 for analyzing inference data 644 to generate inferences, outcomes, or predictions, as examples of a prediction/inference data 638. For example, during prediction phase 626, the trained machine-learning model 618 generates an output. Inference data 644 is provided as an input to the trained machine-learning model 618, and the trained machine-learning model 618 generates the prediction/inference data 638 as output, responsive to receipt of the inference data 644.

In some examples, the trained machine-learning model 618 can be a generative AI model. Generative AI is a term that can refer to any type of artificial intelligence that can create new content from training data 622. For example, generative AI can produce text, images, video, audio, code, or synthetic data similar to the original data but not identical. In cases where the trained machine-learning model 618 is a generative AI, inference data 644 can include text, audio, image, video, numeric, or media content prompts and the output prediction/inference data 638 can include text, images, video, audio, code, or synthetic data.

Some of the techniques that can be used in generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

FIG. 7A is a block diagram showing an example digital interaction system 700 for facilitating interactions and engagements (e.g., exchanging text messages, conducting text audio and video calls, or playing games) over a network. The digital interaction system 700 includes multiple systems that can be used by a user, such as user system 702, XR device 764, and the like, each of which hosts multiple applications, including an interaction client and other applications 706. Each interaction client 704 is communicatively coupled, via one or more networks including a network 708 (e.g., the Internet), to other instances of the interaction client 704 (e.g., hosted on respective other user systems), a server system 710 and third-party servers 712). An interaction client 704 can also communicate with locally hosted applications 706 using Applications Program Interfaces (APIs).

An XR device 764 or a user system 702 can comprise one or more user devices, such as a mobile device 240, a head-wearable apparatus 100, a computer client device 714, and the like that are communicatively connected to exchange data and messages.

An interaction client 704 interacts with other interaction clients 704 and with the server system 710 via the network 708. The data exchanged between the interaction clients 704 (e.g., interactions 716) and between the interaction clients 704 and the server system 710 includes functions (e.g., commands to invoke functions) and payload data (e.g., text, audio, video, or other multimedia data).

The server system 710 provides server-side functionality via the network 708 to the interaction clients 704. While certain functions of the digital interaction system 700 are described herein as being performed by either an interaction client 704 or by the server system 710, the location of certain functionality either within the interaction client 704 or the server system 710 can be a design choice. For example, it can be technically preferable to initially deploy particular technology and functionality within the server system 710 but to later migrate this technology and functionality to the interaction client 704 where a user system 702 has sufficient processing capacity.

The server system 710 supports various services and operations that are provided to the interaction clients 704. Such operations include transmitting data to, receiving data from, and processing data generated by the interaction clients 704. This data can include message content, client device information, geolocation information, digital effects (e.g., media augmentation and overlays), message content persistence conditions, entity relationship information, and live event information. Data exchanges within the digital interaction system 700 are invoked and controlled through functions available via user interfaces (UIs) of the interaction clients 704.

Turning now specifically to the server system 710, an Application Program Interface (API) server 718 is coupled to and provides programmatic interfaces to servers 720, making the functions of the servers 720 accessible to interaction clients 704, other applications 706 and third-party server 712. The servers 720 are communicatively coupled to a database server 722, facilitating access to a database 724 that stores data associated with interactions processed by the servers 720. Similarly, a web server 726 is coupled to the servers 720 and provides web-based interfaces to the servers 720. To this end, the web server 726 processes incoming network requests over the Hypertext Transfer Protocol (HTTP) and several other related protocols.

The Application Program Interface (API) server 718 receives and transmits interaction data (e.g., commands and message payloads) between the servers 720 and the user systems 702 (and, for example, interaction clients 704 and other application 706) and the third-party server 712. Specifically, the Application Program Interface (API) server 718 provides a set of interfaces (e.g., routines and protocols) that can be called or queried by the interaction client 704 and other applications 706 to invoke functionality of the servers 720. The Application Program Interface (API) server 718 exposes various functions supported by the servers 720, including account registration; login functionality; the sending of interaction data, via the servers 720, from a particular interaction client 704 to another interaction client 704; the communication of media files (e.g., images or video) from an interaction client 704 to the servers 720; the settings of a collection of media data (e.g., a narrative); the retrieval of a list of friends of a user of a user system 702; the retrieval of messages and content; the addition and deletion of entities (e.g., friends) to an entity relationship graph; the location of friends within an entity relationship graph; and opening an application event (e.g., relating to the interaction client 704).

The interaction client 704 provides a user interface that allows users to access features and functions of an external resource, such as a linked application 706, an applet, or a microservice. This external resource can be provided by a third party or by the creator of the interaction client 704.

The external resource can be a full-scale application installed on the user's system 702, or a smaller, lightweight version of the application, such as an applet or a microservice, hosted either on the user's system or remotely, such as on third-party servers 712 or in the cloud. These smaller versions, which include a subset of the full application's features, can be implemented using a markup-language document and can also incorporate a scripting language and a style sheet.

When a user selects an option to launch or access the external resource, the interaction client 704 determines whether the resource is web-based or a locally installed application. Locally installed applications can be launched independently of the interaction client 704, while applets and microservices can be launched or accessed via the interaction client 704.

If the external resource is a locally installed application, the interaction client 704 instructs the user's system to launch the resource by executing locally stored code. If the resource is web-based, the interaction client 704 communicates with third-party servers to obtain a markup-language document corresponding to the selected resource, which it then processes to present the resource within its user interface.

The interaction client 704 can also notify users of activity in one or more external resources. For instance, it can provide notifications relating to the use of an external resource by one or more members of a user group. Users can be invited to join an active external resource or to launch a recently used but currently inactive resource.

The interaction client 704 can present a list of available external resources to a user, allowing them to launch or access a given resource. This list can be presented in a context-sensitive menu, with icons representing different applications, applets, or microservices varying based on how the menu is launched by the user.

FIG. 7B is a block diagram illustrating further details regarding the digital interaction system 700, according to some examples. Specifically, the digital interaction system 700 is shown to comprise the interaction client 762 and the servers 760. The digital interaction system 700 embodies multiple subsystems, which are supported on the client-side by the interaction client 762 and on the server-side by the servers 760. In some examples, these subsystems are implemented as microservices. A microservice subsystem (e.g., a microservice application) may have components that enable it to operate independently and communicate with other services. Example components of micro service subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 700.
Data storage: A microservice subsystem may be responsible for its own data storage, which may be in the form of a database, cache, or other storage mechanism (e.g., using the database server 722 and database 724). This enables a microservice subsystem to operate independently of other microservices of the digital interaction system 700.
Service discovery: Microservice subsystems may find and communicate with other microservice subsystems of the digital interaction system 700. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 700 may employ a monolithic architecture, a service-oriented architecture (SOA), a function-as-a-service (FaaS) architecture, or a modular architecture:

Example subsystems are discussed below.

An image processing system 728 provides various functions that enable a user to capture and modify (e.g., augment, annotate or otherwise edit) media content associated with a message.

A camera system 730 includes control software (e.g., in a camera application) that interacts with and controls hardware camera hardware (e.g., directly or via operating system controls) of the user system 702 to modify real-time images captured and displayed via the interaction client 762.

The digital effect system 732 provides functions related to the generation and publishing of digital effects (e.g., media overlays) for images captured in real-time by cameras of the user system 702 or retrieved from memory of the user system 702. For example, the digital effect system 732 operatively selects, presents, and displays digital effects (e.g., media overlays such as image filters or modifications) to the interaction client 762 for the modification of real-time images received via the camera system 730 or stored images retrieved from memory 202 of a user system 702. These digital effects are selected by the digital effect system 732 and presented to a user of an interaction client 762, based on a number of inputs and data, such as for example:
Geolocation of the user system 702; and
Entity relationship information of the user of the user system 702.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 702 for communication in a message, or applied to video content, such as a video content stream or feed transmitted from an interaction client 762. As such, the image processing system 728 may interact with, and support, the various subsystems of the communication system 734, such as the messaging system 736 and the video communication system 738.

A media overlay may include text or image data that can be overlaid on top of a photograph taken by the user system 702 or a video stream produced by the user system 702. In some examples, the media overlay may be a location overlay (e.g., Venice beach), a name of a live event, or a name of a merchant overlay (e.g., Beach Coffee House). In further examples, the image processing system 728 uses the geolocation of the user system 702 to identify a media overlay that includes the name of a merchant at the geolocation of the user system 702. The media overlay may include other indicia associated with the merchant. The media overlays may be stored in the databases 724 and accessed through the database server 722.

The image processing system 728 provides a user-based publication platform that enables users to select a geolocation on a map and upload content associated with the selected geolocation. The user may also specify circumstances under which a particular media overlay should be offered to other users. The image processing system 728 generates a media overlay that includes the uploaded content and associates the uploaded content with the selected geolocation.

The digital effect creation system 740 supports augmented reality developer platforms and includes an application for content creators (e.g., artists and developers) to create and publish digital effects (e.g., augmented reality experiences) of the interaction client 762. The digital effect creation system 740 provides a library of built-in features and tools to content creators including, for example custom shaders, tracking technology, and templates.

In some examples, the digital effect creation system 740 provides a merchant-based publication platform that enables merchants to select a particular digital effect associated with a geolocation via a bidding process. For example, the digital effect creation system 740 associates a media overlay of the highest bidding merchant with a corresponding geolocation for a predefined amount of time.

A communication system 734 is responsible for enabling and processing multiple forms of communication and interaction within the digital interaction system 700 and includes a messaging system 736, an audio communication system 742, and a video communication system 738. The messaging system 736 is responsible, in some examples, for enforcing the temporary or time-limited access to content by the interaction clients 762. The messaging system 736 incorporates multiple timers that, based on duration and display parameters associated with a message or collection of messages (e.g., a narrative), selectively enable access (e.g., for presentation and display) to messages and associated content via the interaction client 762. The audio communication system 742 enables and supports audio communications (e.g., real-time audio chat) between multiple interaction clients 762. Similarly, the video communication system 738 enables and supports video communications (e.g., real-time video chat) between multiple interaction clients 762.

A user management system 744 is operationally responsible for the management of user data and profiles, and maintains entity information (e.g., stored in entity tables, entity graphs, and profile data) regarding users and relationships between users of the digital interaction system 700.

A collection management system 746 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 746 may also be responsible for publishing an icon that provides notification of a particular collection to the user interface of the interaction client 762. The collection management system 746 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 746 employs machine vision (or image recognition technology) and content rules to curate a content collection automatically. In certain examples, compensation may be paid to a user to include user-generated content into a collection. In such cases, the collection management system 746 operates to automatically make payments to such users to use their content.

A map system 748 provides various geographic location (e.g., geolocation) functions and supports the presentation of map-based media content and messages by the interaction client 762. For example, the map system 748 enables the display of user icons or avatars (e.g., stored in profile data) on a map to indicate a current or past location of “friends” of a user, as well as media content (e.g., collections of messages including photographs and videos) generated by such friends, within the context of a map. For example, a message posted by a user to the digital interaction system 700 from a specific geographic location may be displayed within the context of a map at that particular location to “friends” of a specific user on a map interface of the interaction client 762. A user can furthermore share his or her location and status information (e.g., using an appropriate status avatar) with other users of the digital interaction system 700 via the interaction client 762, with this location and status information being similarly displayed within the context of a map interface of the interaction client 762 to selected users.

A game system 750 provides various gaming functions within the context of the interaction client 762. The interaction client 762 provides a game interface providing a list of available games that can be launched by a user within the context of the interaction client 762 and played with other users of the digital interaction system 700. The digital interaction system 700 further enables a particular user to invite other users to participate in the play of a specific game by issuing invitations to such other users from the interaction client 762. The interaction client 762 also supports audio, video, and text messaging (e.g., chats) within the context of gameplay, provides a leaderboard for the games, and supports the provision of in-game rewards (e.g., coins and items).

An external resource system 752 provides an interface for the interaction client 762 to communicate with remote servers (e.g., third-party servers 712) to launch or access external resources, i.e., applications or applets. Each third-party server 712 hosts, for example, a markup language (e.g., HTML5) based application or a small-scale version of an application (e.g., game, utility, payment, or ride-sharing application). The interaction client 762 may launch a web-based resource (e.g., application) by accessing the HTML5 file from the third-party servers 712 associated with the web-based resource. Applications hosted by third-party servers 712 are programmed in JavaScript leveraging a Software Development Kit (SDK) provided by the servers 760. The SDK includes Application Programming Interfaces (APIs) with functions that can be called or invoked by the web-based application. The servers 760 host a JavaScript library that provides a given external resource access to specific user data of the interaction client 762. HTML5 is an example of technology for programming games, but applications and resources programmed based on other technologies can be used.

To integrate the functions of the SDK into the web-based resource, the SDK is downloaded by the third-party server 712 from the servers 760 or is otherwise received by the third-party server 712. Once downloaded or received, the SDK is included as part of the application code of a web-based external resource. The code of the web-based resource can then call or invoke certain functions of the SDK to integrate features of the interaction client 762 into the web-based resource.

The SDK stored on the server system 710 effectively provides the bridge between an external resource (e.g., applications 706 or applets) and the interaction client 762. This gives the user a seamless experience of communicating with other users on the interaction client 762 while also preserving the look and feel of the interaction client 762. To bridge communications between an external resource and an interaction client 762, the SDK facilitates communication between third-party servers 712 and the interaction client 762. A bridge script running on a user system 702 establishes two one-way communication channels between an external resource and the interaction client 762. Messages are sent between the external resource and the interaction client 762 via these communication channels asynchronously. Each SDK function invocation is sent as a message and callback. Each SDK function is implemented by constructing a unique callback identifier and sending a message with that callback identifier.

By using the SDK, not all information from the interaction client 762 is shared with third-party servers 712. The SDK limits which information is shared based on the needs of the external resource. Each third-party server 712 provides an HTML5 file corresponding to the web-based external resource to servers 760. The servers 760 can add a visual representation (such as a box art or other graphic) of the web-based external resource in the interaction client 762. Once the user selects the visual representation or instructs the interaction client 762 through a GUI of the interaction client 762 to access features of the web-based external resource, the interaction client 762 obtains the HTML5 file and instantiates the resources to access the features of the web-based external resource.

The interaction client 762 presents a graphical user interface (e.g., a landing page or title screen) for an external resource. During, before, or after presenting the landing page or title screen, the interaction client 762 determines whether the launched external resource has been previously authorized to access user data of the interaction client 762. In response to determining that the launched external resource has been previously authorized to access user data of the interaction client 762, the interaction client 762 presents another graphical user interface of the external resource that includes functions and features of the external resource. In response to determining that the launched external resource has not been previously authorized to access user data of the interaction client 762, after a threshold period of time (e.g., 3 seconds) of displaying the landing page or title screen of the external resource, the interaction client 762 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 762 adds the external resource to a list of authorized external resources and allows the external resource to access user data from the interaction client 762. The external resource is authorized by the interaction client 762 to access the user data under an OAuth 2 framework.

The interaction client 762 controls the type of user data that is shared with external resources based on the type of external resource being authorized. For example, external resources that include full-scale applications (e.g., an application 706) are provided with access to a first type of user data (e.g., two-dimensional avatars of users with or without different avatar characteristics). As another example, external resources that include small scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 754 operationally enables the purchasing of advertisements by third parties for presentation to end-users via the interaction clients 762 and handles the delivery and presentation of these advertisements.

An artificial intelligence and machine learning system 756 provides a variety of services to different subsystems within the digital interaction system 700. For example, the artificial intelligence and machine learning system 756 operates with the image processing system 728 and the camera system 730 to analyze images and extract information such as objects, text, or faces. This information can then be used by the image processing system 728 to enhance, filter, or manipulate images. The artificial intelligence and machine learning system 756 may be used by the digital effect system 732 to generate modified content and augmented reality experiences, such as adding virtual objects or animations to real-world images. The communication system 734 and messaging system 736 may use the artificial intelligence and machine learning system 756 to analyze communication patterns and provide insights into how users interact with each other and provide intelligent message classification and tagging, such as categorizing messages based on sentiment or topic. The artificial intelligence and machine learning system 756 may also provide chatbot functionality to message interactions 716 between user systems 702 and between a user system 702 and the server system 710. The artificial intelligence and machine learning system 756 may also work with the audio communication system 742 to provide speech recognition and natural language processing capabilities, allowing users to interact with the digital interaction system 700 using voice commands.

A compliance system 758 facilitates compliance by the digital interaction system 700 with data privacy and other regulations, including for example the California Consumer Privacy Act (CCPA), General Data Protection Regulation (GDPR), and Digital Services Act (DSA). The compliance system 758 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 758 also incorporates opt-in/opt-out management and privacy controls across the digital interaction system 700, empowering users to manage their data preferences. The compliance system 758 is designed to handle sensitive data by obtaining explicit consent, implementing strict access controls and in accordance with applicable laws.

Described implementations of the subject matter can include one or more features, alone or in combination as illustrated below by way of example.

Example 1 is a method comprising: determining, using tracking data captured by an extended Reality (XR) device, a proximity of a hand of a user to the XR device; detecting, using a vibration detection sensor of the XR device, a vibration indicating physical contact with the XR device; activating, in response to the detected vibration and the proximity, at least one audio sensor of the XR device; analyzing audio data captured by the at least one audio sensor to determine a touch gesture type; and performing a function by the XR device based on the determined touch gesture type.

In Example 2, the subject matter of Example 1 includes, wherein the touch gesture type comprises at least one of a tap gesture or a swipe gesture.

In Example 3, the subject matter of any of Examples 1-2 includes, wherein analyzing the audio data further comprises determining a touch location or touch side on the XR device.

In Example 4, the subject matter of any of Examples 1-3 includes, wherein the touch location or touch side comprises one of a left side or a right side of the XR device.

In Example 5, the subject matter of any of Examples 1-4 includes, wherein analyzing the audio data further comprises determining a swipe direction.

In Example 6, the subject matter of any of any of Examples 1-5 includes, wherein the swipe direction comprises one of a forward direction or a backward direction.

In Example 7, the subject matter of any of Examples 1-6 includes, wherein analyzing the audio data further comprises: transforming the audio data into a frequency domain representation; and identifying patterns in the frequency domain representation that correspond to specific touch gesture types.

In Example 8, the subject matter of any of Examples 7 includes, wherein the frequency domain representation comprises a Mel spectrogram.

In Example 9, the subject matter of any of Examples 1-8 includes, wherein analyzing the audio data further comprises applying a machine learning model trained to classify touch gesture types based on audio patterns.

In Example 10, the subject matter of any of Examples 1-9 includes, wherein analyzing the audio data further comprises comparing signal strengths from multiple audio sensors to determine a touch location or touch side.

In Example 11, the subject matter of any of Examples 1-10 includes, deactivating the at least one audio sensor after determining the touch gesture type; and discarding the audio data after analyzing to preserve privacy.

In Example 12, the subject matter of any of Examples 1-11 includes, wherein determining the proximity of the hand of the user to the XR device comprises: tracking a trajectory of the hand using the tracking data; and determining that the trajectory indicates movement toward the XR device.

In Example 13, the subject matter of any of Examples 1-12 includes, filtering potential false detections by comparing the determined touch gesture type with the detected vibration and the determined proximity of the hand of the user to the XR device.

In Example 14, the subject matter of any of Examples 1-13 includes, wherein the function of the XR device comprises at least one of: capturing media, navigating content, controlling playback, or scrolling.

In Example 15, the subject matter of any of Examples 1-14 includes, determining which hand of the user is in proximity to the XR device; and validating the touch location or touch side based on the determined hand.

Example 16 is at least one machine-readable medium including instructions that, when executed by processing circuitry, cause the processing circuitry to perform operations to implement any of Examples 1-15.

Example 17 is an apparatus comprising means to implement any of Examples 1-15.

Example 18 is a system to implement any of Examples 1-15.

Example 19 is a method to implement any of Examples 1-15.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### TERM EXAMPLES

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can comprise two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and can be used interchangeably in this disclosure.

“User device” can include, for example, a device accessed, controlled or owned by a user and with which the user interacts perform an action, engagement or interaction on the user device, including an interaction with other users or computer systems.

1. A method comprising:
determining, using tracking data captured by an extended Reality (XR) device, a proximity of a hand of a user to the XR device;
detecting, using a vibration detection sensor of the XR device, a vibration indicating physical contact with the XR device;
activating, in response to the detected vibration and the proximity, at least one audio sensor of the XR device;
analyzing audio data captured by the at least one audio sensor to determine a touch gesture type, the audio data comprising acoustic signals generated by physical contact with a frame of the XR device and propagated through the frame to the at least one audio sensor the analyzing of the audio data comprising transforming the audio data into a frequency domain representation and identifying patterns in the frequency domain representation that correspond to specific touch gesture types;
validating the touch gesture type by comparing the touch gesture type against the detected vibration and the determined proximity of the hand to confirm that the detected vibration, the determined proximity, and the determined touch gesture type correspond to a same physical interaction event; and
in response to validating the touch gesture type, performing a function by the XR device based on the determined touch gesture type.

2. The method of claim 1, wherein the touch gesture type comprises at least one of a tap gesture or a swipe gesture.

3. The method of claim 1, wherein analyzing the audio data further comprises determining a touch side on the XR device.

4. The method of claim 3, wherein the touch side comprises one of a left side or a right side of the XR device.

5. The method of claim 1, wherein analyzing the audio data further comprises:
transforming the audio data into a frequency domain representation comprising a Mel spectrogram in which an x-axis represents time and a y-axis represents frequency strength;
identifying, using a machine learning model, patterns in the Mel spectrogram that correspond to specific touch gesture types, the specific touch gesture types comprising at least a tap gesture and a swipe gesture, the tap gesture is identified based on a first pattern in the Mel spectrogram corresponding to a short impulse and the swipe gesture is identified based on a second pattern in the Mel spectrogram corresponding to a longer audio signal with a changing intensity pattern; and
discarding the audio data after identifying the patterns.

6. The method of claim 1, wherein analyzing the audio data further comprises comparing signal strengths from multiple audio sensors to determine a touch side.

7. The method of claim 1, wherein the XR device is a head-wearable apparatus.

8. A machine comprising:
at least one processor; and
at least one memory storing instructions that, when executed by the at least one processor, cause the machine to perform operations comprising:
determining, using tracking data captured by an extended Reality (XR) device, a proximity of a hand of a user to the XR device;
detecting, using a vibration detection sensor of the XR device, a vibration indicating physical contact with the XR device;
activating, in response to the detected vibration and the proximity, at least one audio sensor of the XR device;
analyzing audio data captured by the at least one audio sensor to determine a touch gesture type, the audio data comprising acoustic signals generated by physical contact with a frame of the XR device and propagated through the frame to the at least one audio sensor, the analyzing of the audio data comprising transforming the audio data into a frequency domain representation and identifying patterns in the frequency domain representation that correspond to specific touch gesture types;
validating the touch gesture type by comparing the touch gesture type against the detected vibration and the determined proximity of the hand to confirm that the detected vibration, the determined proximity, and the determined touch gesture type correspond to a same physical interaction event; and
in response to validating the touch gesture type, performing a function by the XR device based on the determined touch gesture type.

9. The machine of claim 8, wherein the touch gesture type comprises at least one of a tap gesture or a swipe gesture.

10. The machine of claim 8, wherein analyzing the audio data further comprises determining a touch side on the XR device.

11. The machine of claim 10, wherein the touch side comprises one of a left side or a right side of the XR device.

12. The machine of claim 8, wherein analyzing the audio data further comprises:
transforming the audio data into a frequency domain representation comprising a Mel spectrogram in which an x-axis represents time and a y-axis represents frequency strength;
identifying, using a machine learning model, patterns in the Mel spectrogram that correspond to specific touch gesture types, the specific touch gesture types comprising at least a tap gesture and a swipe gesture, the tap gesture is identified based on a first pattern in the Mel spectrogram corresponding to a short impulse and the swipe gesture is identified based on a second pattern in the Mel spectrogram corresponding to a longer audio signal with a changing intensity pattern; and
discarding the audio data after identifying the patterns.

13. The machine of claim 8, wherein analyzing the audio data further comprises comparing signal strengths from multiple audio sensors to determine a touch side.

14. The machine of claim 8, wherein the XR device is a head-wearable apparatus.

15. A machine-storage medium, the machine-storage medium including instructions that, when executed by a machine, cause the machine to perform operations comprising:
determining, using tracking data captured by an extended Reality (XR) device, a proximity of a hand of a user to the XR device;
detecting, using a vibration detection sensor of the XR device, a vibration indicating physical contact with the XR device;
activating, in response to the detected vibration and the proximity, at least one audio sensor of the XR device;
analyzing audio data captured by the at least one audio sensor to determine a touch gesture type, the audio data comprising acoustic signals generated by physical contact with a frame of the XR device and propagated through the frame to the at least one audio sensor, the analyzing of the audio data comprising transforming the audio data into a frequency domain representation and identifying patterns in the frequency domain representation that correspond to specific touch gesture types;
validating the touch gesture type by comparing the touch gesture type against the detected vibration and the determined proximity of the hand to confirm that the detected vibration, the determined proximity, and the determined touch gesture type correspond to a same physical interaction event; and
in response to validating the touch gesture type performing a function by the XR device based on the determined touch gesture type.

16. The machine-storage medium of claim 15, wherein the touch gesture type comprises at least one of a tap gesture or a swipe gesture.

17. The machine-storage medium of claim 15, wherein analyzing the audio data further comprises determining a touch side on the XR device.

18. The machine-storage medium of claim 17, wherein the touch side comprises one of a left side or a right side of the XR device.

19. The machine-storage medium of claim 15, wherein analyzing the audio data further comprises:
transforming the audio data into a frequency domain representation comprising a Mel spectrogram in which an x-axis represents time and a y-axis represents frequency strength;
identifying, using a machine learning model, patterns in the Mel spectrogram that correspond to specific touch gesture types, the specific touch gesture types comprising at least a tap gesture and a swipe gesture, the tap gesture is identified based on a first pattern in the Mel spectrogram corresponding to a short impulse and the swipe gesture is identified based on a second pattern in the Mel spectrogram corresponding to a longer audio signal with a changing intensity pattern; and
discarding the audio data after identifying the patterns.

20. The machine-storage medium of claim 15, wherein analyzing the audio data further comprises comparing signal strengths from multiple audio sensors to determine a touch side.
